(19) United States
(12) Patent Application Publication
(10) Pub. No.: US 2011/0235934 A1
(43) Pub. Date: Sep. 29, 2011

(54) IMAGE PROCESSING APPARATUS, IMAGE PROCESSING METHOD, AND PROGRAM

(75) Inventors: Noriaki Takahashi, Tokyo (JP); Takahiro Nagano, Kanagawa (JP); Yasuhiro Suto, Tokyo (JP)

(73) Assignee: Sony Corporation, Tokyo (JP)

(21) Appl. No.: 13/052,323

(22) Filed: Mar. 21, 2011

(30) Foreign Application Priority Data
Mar. 29, 2010 (JP) 2010-076303

(51) Int. Cl. G06K 9/40

(52) U.S. Cl. 382/254

(57) ABSTRACT

An image processing apparatus includes a parameter input unit, a tap extraction unit, a predictive coefficient calculation unit, a predictive coefficient calculation unit, and a pixel value operation unit. The parameter input unit receives a parameter including an output phase, the size of an output pixel, and a variable used for a condensing model. The tap extraction unit extracts a tap including a pixel value of a focus pixel which corresponds to the output phase and pixel values of neighboring pixels of the focus pixel. The predictive coefficient calculation unit calculates a predictive coefficient to be multiplied by each of the elements of the tap. The pixel value operation unit calculates a value of the output pixel by performing a product-sum operation of the calculated predictive coefficient and each of the elements of the tap.

### BACKGROUND OF THE INVENTION

1. Field of the Invention

The present invention relates to an image processing apparatus, an image processing method, and a program, and, more particularly, to an image processing apparatus, an image processing method, and a program capable of improving image quality and implementing image quality conversion processing which can correspond to various conversion patterns using a simple configuration.

2. Description of the Related Art

Image enlargement conversion using statistical learning has been known from the past. For example, a conversion table is prepared in such a way that a pair of a low-resolution image and a high-resolution image (learning pair) is prepared beforehand and the relationship therebetween is statically learned. High-definition enlargement conversion can be implemented by performing conversion processing on an input image using the conversion table.

Further, in order to predict an image which includes no noise from an input image which includes deterioration, such as noise, or in order to convert a Standard-Definition (SD) signal into a high-resolution High-Definition (HD) signal, a method using class classification/adjustment processing has been suggested (for example, refer to Japanese Unexamined Patent Application Publication No. 7-79418).

When an SD signal is converted into an HD signal according to the technology disclosed in Japanese Unexamined Patent Application Publication No. 7-79418, the properties of a class tap including an input SD signal are obtained using Adaptive Dynamic Range Coding (ADRC), and then class classification is performed based on the obtained properties of the class tap. Thereafter, an operation is performed on a predictive coefficient which is prepared for each class and the predictive tap which includes the input SD signal, thereby obtaining the HD signal.

The class classification is performed in such a way that high Signal-to-Noise ratio (S/N) pixels are divided into groups based on the pattern of the pixel values of low S/N pixels which are spatially or timely near to the location of a low S/N image which corresponds to the location of high S/N pixels having a predictive value to be obtained. The adjustment process is performed in order to obtain a proper predictive coefficient with respect to the high S/N pixels included in a group for each group (corresponding to the above-described class), and to improve the image quality using the predictive coefficient. Therefore, basically, it is preferable that the class classification be performed by configuring a class tap using more pixels which are related to the high S/N pixels having a predictive value to be obtained.

However, when a low-resolution image is enlarged to a high-resolution image, if the enlargement is performed at various types of magnification as well as at predetermined single magnification, a number of conversion tables corresponding to the magnification are necessary.

Therefore, the present applicant has proposed a method of preparing a plurality of conversion tables corresponding to discrete magnification beforehand, obtaining the results of conversion performed at intermediate magnification using linear interpolation, and preparing an intermediate conversion table using liner regression between the conversion tables (for example, refer to Japanese Unexamined Patent Application Publication No. 2004-191856).

### SUMMARY OF THE INVENTION

However, even though enlargement is performed at an intermediate magnification as in Japanese Unexamined Patent Application Publication No. 2004-191856, it is difficult to avoid the deterioration in image quality, as compared with the case where a conversion table obtained by direct learning is used.

Further, when a learning pair is hardly prepared beforehand as in enlargement conversion at ultra-high magnification, the method according to the related art hardly deals with the situation.

It is desirable to implement image quality conversion processing capable of improving image quality and corresponding to various conversion patterns using a simple configuration.

According to an embodiment of the invention, there is provided an image processing apparatus including parameter input means for receiving a parameter including an output phase which corresponds to the coordinates of an output pixel, a size of the output pixel, and a variable used for a condensing model; tap extraction means for extracting a tap including a pixel value of a focus pixel which corresponds to the output phase of an input image and pixel values of neighboring pixels of the focus pixel; predictive coefficient calculation means for calculating a predictive coefficient to be multiplied by each of the elements of the tap using the parameter and a coefficient configuration value stored beforehand; and pixel value calculation means for calculating a value of the output pixel by performing a product-sum operation of the calculated predictive coefficient and each of the elements of the tap.

The image processing apparatus according to the above embodiment of the invention further includes a database for storing the coefficient configuration value, and the database stores the coefficient configuration value so that the coefficient configuration value corresponds to information used to identify the elements of the tap.

The image processing apparatus according to the above embodiment of the invention further includes a class classification unit for classifying a peripheral image of the focus pixel of the input image as one of a plurality of classes using a predetermined method, and the database stores the coefficient configuration values for each class.

In the image processing apparatus according to the above embodiment of the invention, an output image including the output pixel is an image a resolution of which is higher than that of the input image.

In the image processing apparatus according to the above embodiment of the invention, the size of the output pixel which is received as the parameter is determined based on the resolution of the output image.

In the image processing apparatus according to the above embodiment of the invention, a value, which is obtained in such a way that values of a plurality of pixels of an infinite-resolution image having resolution higher than that of the output image are integrated according to condensing properties represented by the condensing model, is approximated as the value of the output pixel; the predictive coefficient is described using a function including the parameter and the coefficient configuration value; and the database stores the predictive coefficient learned beforehand using high resolution teacher image and a lower resolution student image, and stores the coefficient configuration value obtained based on the function.

In the image processing apparatus according to the above embodiment of the invention, the condensing model is a Gaussian model.

In the image processing apparatus according to the above embodiment of the invention, the condensing model is a circular model.

According to an embodiment of the invention, there is provided an image processing method including the steps of allowing parameter input means for receiving a parameter including an output phase which corresponds to the coordinates of an output pixel, a size of the output pixel, and a variable used for a condensing model; allowing tap extraction means for extracting a tap including a pixel value of a focus pixel which corresponds to the output phase of an input image and pixel values of neighboring pixels of the focus pixel; allowing predictive coefficient calculation means for calculating a predictive coefficient to be multiplied by each of the elements of the tap using the parameter and a coefficient configuration value stored beforehand; and allowing pixel value calculation means for calculating a value of the output pixel by performing a product-sum operation of the calculated predictive coefficient and each of the elements of the tap.

According to an embodiment of the invention, there is provided a program allowing a computer to function as an image processing apparatus including parameter input means for receiving a parameter including an output phase which corresponds to the coordinates of an output pixel, the size of the output pixel, and a variable used for the condensing model; tap extraction means for extracting a tap including a pixel value of a focus pixel which corresponds to the output phase of an input image and pixel values of neighboring pixels of the focus pixel; predictive coefficient calculation means for calculating a predictive coefficient to be multiplied by each of the elements of the tap using the parameter and a coefficient configuration value stored beforehand; and pixel value calculation means for calculating a value of the output pixel by performing a product-sum operation of the calculated predictive coefficient and each of the elements of the tap.

According to the embodiment of the present invention, a parameter, which includes an output phase which is the coordinates of an output pixel, the size of the output pixel, and a variable used for a condensing model, is input; a tap, which includes the pixel value of a focus pixel corresponding to the output phase of an input image and the pixel values of neighboring pixels of the focus pixel, is extracted; a predictive coefficient, which is multiplied by each of the elements of the tap using the parameter and a coefficient configuration value stored beforehand, is calculated; and the value of the output pixel is calculated by performing product-sum operation on the calculated predictive coefficient and each of the elements of the tap.

According to the embodiment of the present invention, it is possible to implement image quality conversion processing capable of improving image quality and corresponding to various conversion patterns using a simple configuration.

### BRIEF DESCRIPTION OF THE DRAWINGS

FIG. 1 is a block diagram illustrating an example of the configuration of an image processing apparatus according to the related art;

FIG. 2 is a view illustrating the learning of a predictive coefficient;

FIG. 3 is a view illustrating an example of a learning pair according to magnification;

FIG. 4 is a view illustrating an example of the calculation of a predictive coefficient according to an embodiment of the present invention;

FIG. 5 is a view illustrating the relationship among a low-resolution image, an infinite-resolution image, and a high-resolution image;

FIG. 6 is a view illustrating the configuration of the pixel of the high-resolution image;

FIG. 7 is a view illustrating an example of a case where enlargement conversion is performed on the low-resolution image at magnification 5×5;

FIG. 8 is a view illustrating the combination of (i, j) of Equations 3, 7, and 8;

FIG. 9 is a view illustrating an example of a case where enlargement conversion is performed on the low-resolution image at magnification 3×3;

FIG. 10 is a view illustrating a circular model;

FIG. 11 is a view corresponding to FIG. 6 and illustrating a case where a circular model is used as a condensing model;

FIG. 12 is a block diagram illustrating an example of the configuration of an image processing apparatus according to an embodiment of the present invention;

FIG. 13 is a flowchart illustrating an example of enlargement conversion processing performed by the image processing apparatus of FIG. 12;

FIG. 14 is a view illustrating another example of the calculation of a predictive coefficient according to an embodiment of the present invention;

FIG. 15 is a view illustrating a method of implementing higher-definition enlargement conversion according to an embodiment of the present invention;

FIG. 16 is a view illustrating an effect obtained when enlargement conversion processing is performed using the method illustrated in FIG. 15;

FIG. 17 is a block diagram illustrating an example of the configuration of a television receiver in which the image processing apparatus according to an embodiment of the present invention is mounted; and

FIG. 18 is a block diagram illustrating an example of the configuration of a personal computer.

### DESCRIPTION OF THE PREFERRED EMBODIMENTS

The embodiments of the present invention will be described with reference to the drawings below.

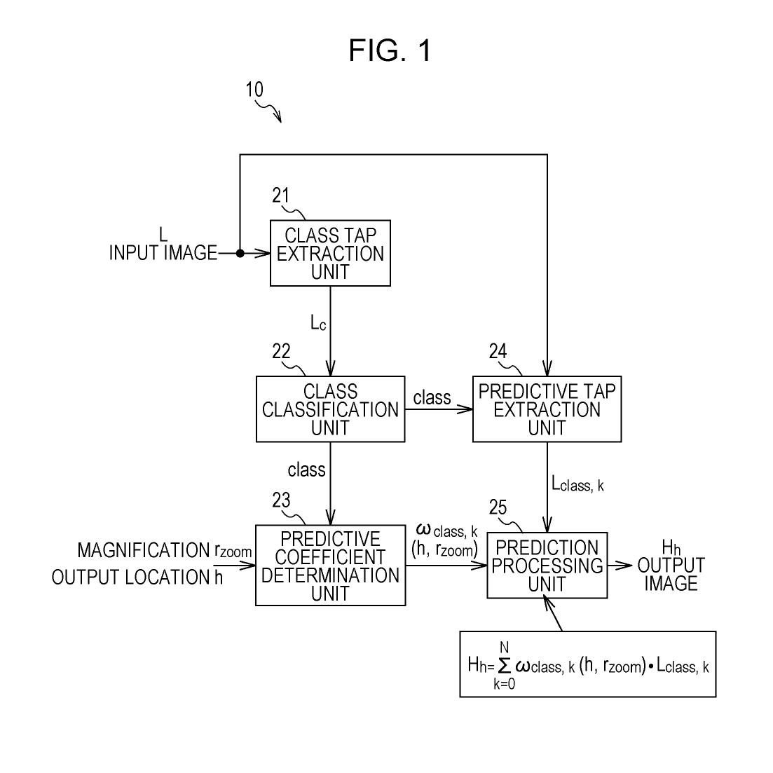

Image enlargement conversion according to the related art will be described first. FIG. 1 is a block diagram illustrating an example of the configuration of an image processing apparatus 10 according to the related art. The image processing apparatus 10 shown in the drawing is configured in such a way that, for example, a low-resolution image L is input as an input image, a high-resolution H pixel Hₕ is generated based on the predetermined pixel of the image L, and the pixel Hₕ is output as an output image. That is, image enlargement conversion is performed by the image processing apparatus 10.

The input image is provided to a class tap extraction unit 21, and a focus pixel is set. The class tap extraction unit 21 is configured to, for example, extract a class tap L_{c} which includes the value of a focus pixel and the values of neighboring pixels around the focus pixel. The class tap corresponds to, for example, one of several to dozens of dimensional vectors.

A class classification unit 22 classifies the corresponding class tap as a predetermined class by analyzing the extracted class tap, and determines the class.

A predictive coefficient determination unit 23 is configured to read out a predictive coefficient from a storage unit (Read Only Memory (ROM)), the predictive coefficient being necessary to generate a pixel which is located at the pixel location h (called phase) of the output image and corresponds to the focus pixel of the input image and being assigned to the class which has been determined by the class classification unit 22. Meanwhile, a predictive coefficient ω_{class, k}(h, r_{zoom}) is stored beforehand for each class according to magnification r_{zoom} for an image and the phase h of the pixel of the output image, and corresponds to a vector which includes the same number of the elements as the predictive tap.

A predictive tap extraction unit 24 extracts a predictive tap from the input image, the predictive tap being determined beforehand in correspondence with the class determined by the class classification unit 22. The predictive tap L_{class, k} includes the value of a focus pixel and the values of neighboring pixels around the focus pixel, and is configured as a vector that includes k elements in this example.

A prediction processing unit 25 is configured to perform a product-sum operation on each of the elements of the predictive tap provided from the predictive tap extraction unit 24 and each of the elements of the predictive coefficient provided from the predictive coefficient determination unit 23, thereby generating and outputting a specific pixel Hₕ of a high-resolution image.

For example, when the pixel value of a pixel at a pixel location h of a high-resolution image is calculated, if a predictive tap includes the values of 9 pixels centering on the focus pixel, an operation is performed as follows. The predictive coefficient determination unit 23 reads a predictive coefficient when the phase of the pixel of the output image is the pixel location h. Thereafter, the product of the first element of the predictive coefficient and the first element of the predictive tap is calculated, the product of the second element of the predictive coefficient and the second element of the predictive tap is calculated, . . . , and the product of the ninth element of the predictive coefficient and the ninth element of the predictive tap is calculated. Thereafter, the sum of the products is calculated, and the result of the sum becomes the pixel value of the pixel Hₕ of the high-resolution image.

Furthermore, for example, when the pixel value of the pixel location i of the high-resolution image is calculated, the predictive coefficient determination unit 23 reads a predictive coefficient (including 9 elements) when the phase of the pixel of the output image is the pixel location i, and the above-described operation is performed.

For example, in the case of magnification 5×5, the pixel values of 25 pixels of an output image are calculated based on the predictive tap which includes one pixel of the input image as a focus pixel. In this case, since the number of phases of the pixels of the output image is 25, predictive coefficients, which are classified into the same class, are prepared in accordance with the phases of the pixels of the output image. Thereafter, since the predictive tap includes 9 elements, each of the 25 predictive coefficients includes 9 elements.

The image enlargement conversion has been performed as described above according to the related art.

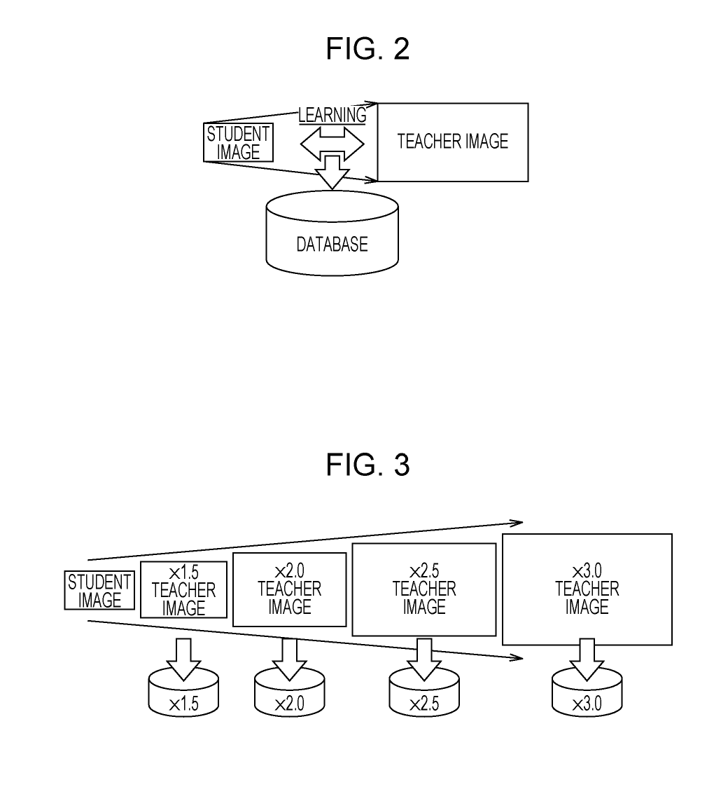

A predictive coefficient which has been used according to the related art is generated based on a learning pair which includes the combination of a student image and a teacher image. FIG. 2 is a view illustrating the learning of a predictive coefficient. As shown in the drawing, learning of a predictive coefficient is performed based on a teacher image which is a high-resolution image and a student image which is a low-resolution image obtained by degenerating the number of pixels of the teacher image. Meanwhile, the area of the low-resolution image is described to be smaller than that of the high-resolution image when the area of the low-resolution image is compared with that of the high-resolution image in the drawing.

For example, learning is performed in such a way that the pixel value of the teacher image is regarded as a true value, a plurality of samples, each including the combination of a tap extracted from the student image and the true value, are obtained, and a coefficient in a primary linear expression used to calculate a true value by using the tap as a parameter is regarded as a predictive coefficient. A learned predictive coefficient is stored in a database. Meanwhile, for example, information about conversion such as a method of extracting a class tap is stored in the database together with the predictive coefficient if necessary.

As described above, when a predictive coefficient is learned using a learning pair, it is necessary to prepare a learning pair based on magnification. For example, when an image processing apparatus is configured to perform enlargement conversion at magnification of 1.5, 2, 2.5, and 3 times, it is necessary to prepare respective databases according to the magnification. For example, it is necessary that the combinations of a student image and a teacher image, which correspond to the respective magnification of 1.5 times (×1.5), 2 times (×2.0), 2.5 times (×2.5) and 3 times (×3.0), are prepared as shown in FIG. 3, and that a predictive coefficient is learned based on each learning pair.

Therefore, it is necessary to separately prepare a database for storing a predictive coefficient for magnification of 1.5 times, a database for storing a predictive coefficient for magnification of 2 times, . . . , so that the cost increases.

Here, in an embodiment of the present invention, an integrated database for storing one or more predictive coefficients and information about conversion, which can be used regardless of magnification, is prepared.

In the embodiment of the present invention, with respect to an image enlarged according to each magnification, the image of an object is integrated according to the condensing properties. That is, it is assumed that a real object is an image enlarged according to infinite magnification, and the pixel of a high-resolution image or a low-resolution image is configured in such a way that a plurality of pixels of an image enlarged according to infinite magnification are gathered. That is, an image enlarged according to infinite magnification is called an infinite-resolution image.

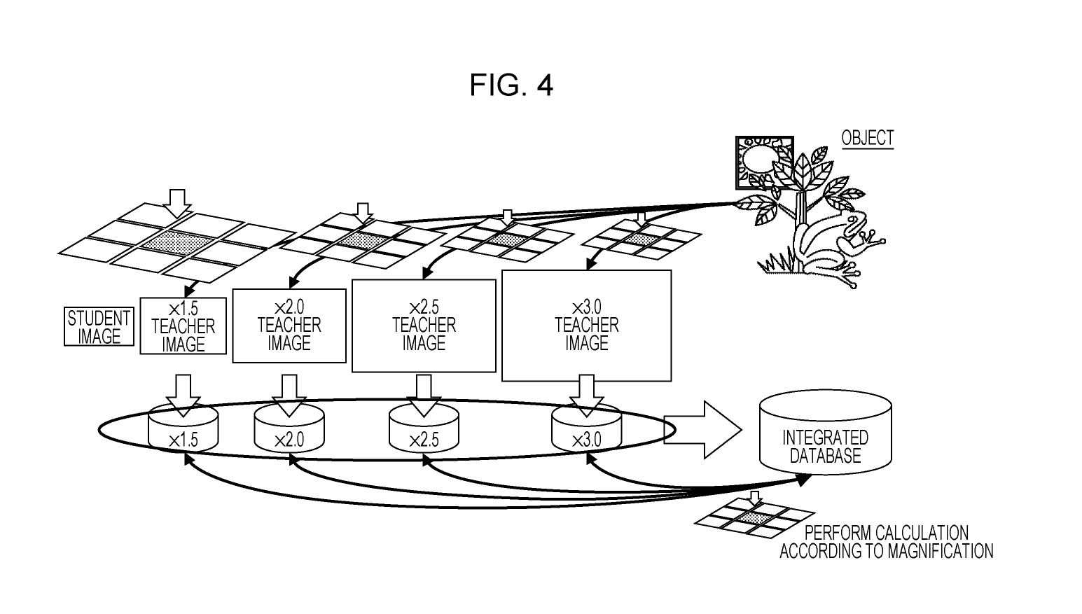

Under the point of view described above, in the embodiment of the present invention, for example, a predictive coefficient and information about conversion which correspond to infinite magnification are stored in the integrated database as shown in FIG. 4, and a predictive coefficient and information about conversion which correspond to magnification stored in the integrated database are calculated.

FIG. 4 illustrates an example in which the image of an object is displayed by pixels having sizes corresponding to respective magnification of 1.5 times, 2 times, 2.5 times, and 3 times. Meanwhile, for the sake of convenience, images corresponding to the respective magnifications are displayed using rectangles each having 3 rows and 3 columns, and the size of each rectangle represents the size of the pixel which has been described above in the drawing. Further, the drawing illustrates that the predictive coefficients corresponding to respective magnification of 1.5 times (×1.5), 2 times (×2.0), 2.5 times (×2.5), and 3 times (×3.0) are not separately stored, and predictive coefficients corresponding to the respective magnification are calculated based on information stored in the integrated database.

The method will be described in detail below.

In the embodiment of the present invention, each pixel value of an infinite-resolution image can be described using a continuous function G(R) which includes the coordinate R=(Rₓ, R_{y}) of the pixel location as a variable. Each of the pixel values of the infinite-resolution image is represented using a pixel value Lₖ of the low-resolution image by Equation 1.

$$G ( R ) ≅ {\sum }_{k = 0}^{N} {W}_{k} ( R ) \cdot {L}_{k} \qquad ( 1 )$$

In Equation 1, a predictive tap is a vector which includes the pixel values of k pixels centering on the focus pixel of the low-resolution image, N represents the number of the elements of the tap, and k represents an element number. Further, in equation 1, the predictive coefficient is configured as a vector including k elements and Wₖ represents the k-th element of the predictive coefficient. Meanwhile, since each element of the predictive coefficient is provided to generate the pixel of a predetermined pixel location of the output image (the infinite-resolution image in this case) as in the method according to the related art, the coordinate R of the pixel location is described as a variable.

Here, the pixel value Hₕ of a high-resolution image (the value of a pixel Hₕ) having resolution which is higher than that of a low-resolution image and lower than that of an infinite-resolution image is considered. As described above, if it is assumed that integration is performed on the pixel values of the infinite-resolution image according to the condensing properties, the pixel value of the high-resolution image is obtained by performing accumulation and integration on the continuous function G(R) and a condensing model S(r) which includes the coordinates r(rx,ry) as a variable. Meanwhile, the coordinate r is a relative coordinate centering on the coordinate R of the infinite-resolution image.

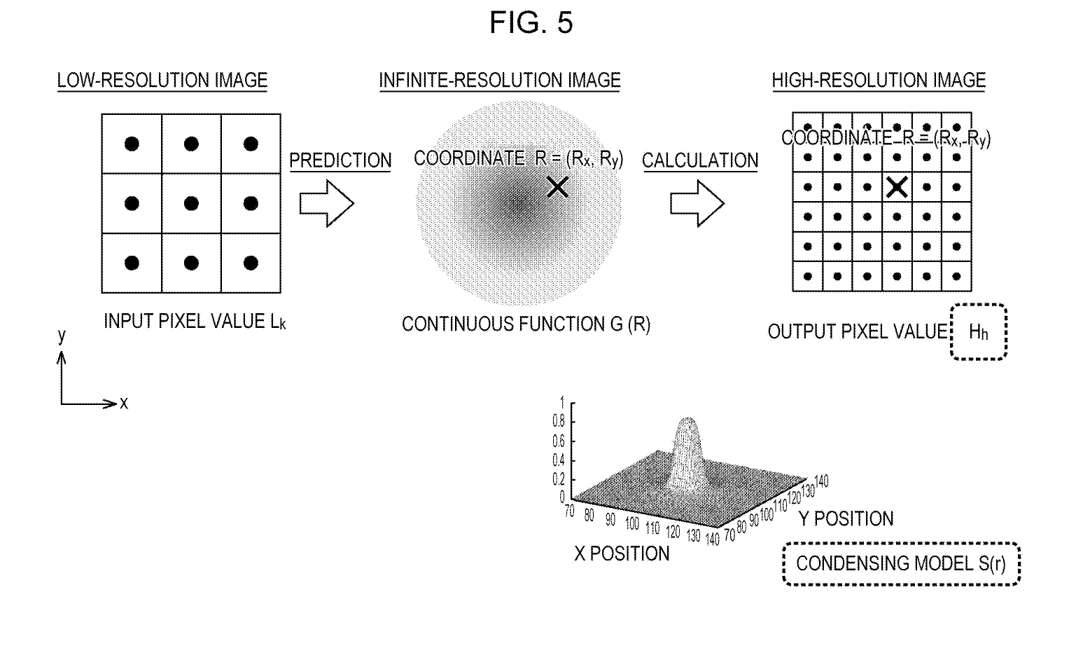

That is, the pixel value Hₕ of the high-resolution image is calculated based on the pixel value G(R), predicted using the pixel value Lₖ of the low-resolution image, using the condensing model S(r) as shown in FIG. 5.

In the drawing, the coordinates of the infinite-resolution image are represented by a dot in the center of the drawing. Further, with respect to the low-resolution image, the image of a unit area includes 9(=3×3) pixels, and the low-resolution image is shown at the left side in the drawing. Further, with respect to the high-resolution image, the image of the unit area includes 36(=6×6) pixels, and the high-resolution image is shown at the right side in the drawing.

Meanwhile, in FIG. 5, the condensing model S(r) is displayed as a 3D (3-Dimensional) spatial diagram which represents the weight coefficient of a Gaussian model and shown at the lower right side in the drawing. As shown in the drawing, on the basis of the coordinates of the xy plane of the infinite-resolution image, the pixel of the low-resolution image corresponds to the plane of a large area, and the pixel of the high-resolution image corresponds to the plane of a small area. That is, the pixel corresponding to the output pixel value Hₕ represents the plane having a predetermined area centering on the coordinate R of the xy plane of the infinite-resolution image.

Therefore, the pixel value Hₕ of the high-resolution image can be approximated to as in Equation 2 using Equation 1.

$$\begin{matrix}{H}_{h} = {\int }_{- ∞}^{∞} {\int }_{- ∞}^{∞} S ( r ) \cdot G ( R + r ) d {r}_{x} d {r}_{y} \\ ≅ {\sum }_{k = 0}^{N} ( {\int }_{- ∞}^{∞} {\int }_{- ∞}^{∞} S ( r ) \cdot {W}_{k} ( R + r ) d {r}_{x} d {r}_{y} ) \cdot {L}_{k} {\sum }_{k = 0}^{N} {D}_{k} ( R ) \cdot {L}_{k}\end{matrix} \qquad ( 2 )$$

Further, according to the embodiment of the present invention, each element Wₖ (R) of the predictive coefficient used in Equation 1 is approximated to using the sum of product expression of an orthogonal function as expressed in Equation 3. Here, a cosine function is used as an example of the orthogonal function. Meanwhile, it is preferable that the value of n in Equation 3 be as large as possible.

$${W}_{k} ( R ) ≅ {\sum }_{i = 0}^{n} {\sum }_{j = 0}^{n - i} {w}_{ijk} cos ( {δ}_{i} {R}_{x} ) \cdot cos ( {δ}_{j} {R}_{y} ) [ \begin{matrix}{δ}_{i} = i π \\ {δ}_{j} = j π\end{matrix} \qquad ( 3 )$$

Thereafter, Dₖ in Equation 2 is approximated by

Equation 4 using the coordinate R of the center of the pixel of the high-resolution image, the pixel size Z of the high-resolution image, and Gaussian parameter σ of the condensing model S(r) as variables. Meanwhile, Dₖ represents one element of a vector which includes a plurality of the elements like a predictive coefficient, and the vector is called new predictive coefficient. Meanwhile, each of the values of a, b, c, and d in Equation 4 is determined based on the pixel size Z.

$$\begin{matrix}{D}_{k} ( R , Z , σ ) = {\int }_{- ∞}^{∞} {\int }_{- ∞}^{∞} S ( r , Z , σ ) \cdot {W}_{k} ( R + r ) d {r}_{x} d {r}_{y} \\ ≅ {\sum }_{i = 0}^{n} {\sum }_{j = 0}^{n - i} {w}_{ijk} \frac{1}{{Z}_{x} {Z}_{y}} \{ b sin c ( {δ}_{i} b ) - a sin c ( {δ}_{i} a ) \} \cdot \\ \{ d sin c ( {δ}_{j} d ) - c sin c ( {δ}_{j} c ) \} \cdot exp ( - \frac{1}{2} {σ}^{2} ( {δ}_{i}^{2} + {δ}_{j}^{2} ) )\end{matrix} \qquad ( 4 )$$

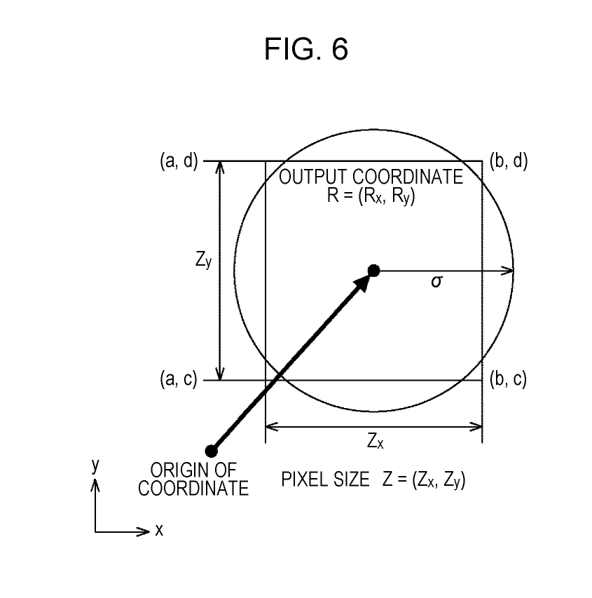

Here, the pixel of the high-resolution image (the pixel corresponding to the pixel value Hₕ) is configured as shown in FIG. 6. That is, the pixel of the high-resolution image is represented as a rectangle which centers on the coordinate R of the xy plane of the infinite-resolution image, and which has a length of Zx in the horizontal direction and a length of Zy in the vertical direction. In the drawing, the points of the four corners of the rectangle which is the pixel of the high-resolution image are respectively represented by coordinates (a,d), (b,d), (a,c), and (b,c) in the xy plane of the infinite-resolution image. Meanwhile, the radius of a circle in the drawing represents the Gaussian parameter σ.

The pixel size Z in FIG. 6 represents, for example, the size of the plane of the pixel of the high-resolution image which has been described with reference to FIG. 5, the Gaussian parameter σ in FIG. 6 represents, for example, a parameter (variable) used for the condensing model which has been described with reference to FIG. 5. Thereafter, the pixel size Z does not represent the size of a pixel which is actually mounted on, for example, a display apparatus but is determined based on the resolution of an image. In the same manner, the Gaussian parameter σ can be arbitrarily set to a proper value as the property of the output image obtained through resolution conversion regardless of actual condensing properties corresponding to the implementation of a display apparatus.

Based on FIG. 6, each of the values of a, b, c, and d in Equation 4 can be drawn using the Following Equation 5:

a=Rₓ−(Zₓ/2)

b=Rₓ+(Zₓ/2)

c=R_{y}−(Z_{y}/2)

d=R_{y}+(Z_{y}/2) (5)

An equality expression is generated in such a way that each of the elements Dₖ(R,Z,σ) of the new predictive coefficient expressed in Equation 4 is assumed, for example, to be equal to each of the elements of the predictive coefficient learned using the method according to the related art which has been described with reference to FIG. 2. Thereafter, wᵢⱼₖ in equation 4 can be obtained in such a way as to solve the simultaneous equation by substituting for the coordinate R, the pixel size Z, and the Gaussian parameter σ which can be specified based on the student image and the teacher image used for learning.

In the embodiment of the present invention, each wᵢⱼₖ in Equation 4 is obtained and stored in the integrated database.

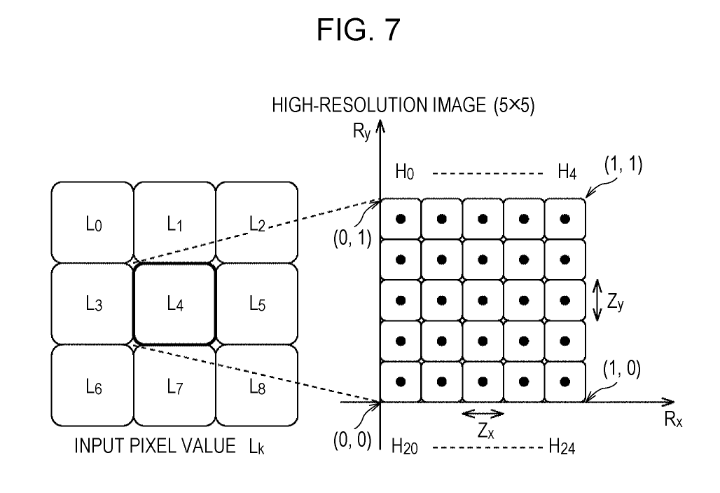

Description will be performed in detail with reference to FIG. 7. FIG. 7 is a view illustrating an example in which enlargement conversion is performed on a low-resolution image at magnification 5×5.

9 rectangles shown in the left side of the drawing represent the tap of the input image (low-resolution image).

In this example, the pixels of the input image are represented using the respective rectangles indicated by reference symbols L₀ to L₈. Further, the focus pixel of the input image is the pixel represented by the rectangle indicated by reference symbol L₄ in the drawing, and the pixel values of the 9(=3×3) pixels centering on the focus pixel constitute a tap.

Furthermore, in this example, 25(=5×5) pixels of the high-resolution image shown at the right side of the drawing are generated in order to correspond to the focus pixel (the rectangle indicated by reference symbol L₄) of the input image. The 25 rectangles shown at the right side of FIG. 7 represent the respective pixels of the high-resolution image which are generated in order to correspond to the focus pixel. Meanwhile, a black dot shown in each rectangle represents the central location of each pixel.

Further, the uppermost left pixel in the drawing is the pixel H₀, and a reference symbol is attached in turn, so that the lowermost right pixel in the drawing is the pixel H₂₄.

Meanwhile, the coordinates of the four corners of the pixel group of the high-resolution image at the right side of FIG. 7 are represented as (0,1), (1, 1), (0,0) and (1, 0) for the sake of convenience. Further, with respect to the high-resolution image in the drawing, 25(=5×5) pixels of the high-resolution image are generated on a plane which corresponds to one pixel of the low-resolution image, so that both the x component and y component of the pixel size Z are 0.2(=⅕). Therefore, the coordinates of the central location of the pixel H₀ can be specified as (0.1,0.9). In the same manner, the coordinates of the central location of the pixel H₁ are specified as (0.3,0.9), . . . , and the coordinates of the central location of the pixel H₂₄ are specified as (0.9,0.1).

With the use of each element ωₕₖ of a predictive coefficient obtained through the preliminary learning and each element Lₖ of a predictive tap extracted from the input image, the pixel value Hₕ of the high-resolution image can be obtained using the following Equation 6:

$${H}_{h} = {\sum }_{k = 0}^{9} {ω}_{hk} \cdot {L}_{k} \qquad ( 6 )$$

Each element ωₕₖ of the predictive coefficient used in Equation 6 is the same as each element of the new predictive coefficient approximated using Equation 4, so that Equation 7 is formed. Meanwhile, the coordinate R which is the parameter of the new predictive coefficient Dₖ(R,Z,σ) is set as the central location of the pixel H₀ of the high-resolution image in Equation 7, and each element of the predictive coefficient which is used to obtain the pixel H₀ of the high-resolution image is represented by the element ω₀ₖ.

$${ω}_{0 , k} = {\sum }_{i = 0}^{n} {\sum }_{j = 0}^{n - i} {w}_{ijk} \frac{1}{{Z}_{x} \times {Z}_{y}} \{ {b}_{0} sin c ( {δ}_{i} {b}_{0} ) - {a}_{0} sin c ( {δ}_{i} {a}_{0} ) \} \cdot \{ {d}_{0} sin c ( {δ}_{j} {d}_{0} ) - {c}_{0} sin c ( {δ}_{j} {c}_{0} ) \} \cdot exp ( - \frac{1}{2} {σ}^{2} ( {δ}_{i}^{2} + {δ}_{j}^{2} ) ) \qquad ( 7 )$$

Each a₀, b₀, c₀ and d₀ in equation 6 represents the coordinates of each of the four corners of a rectangle plane corresponding to the pixel H₀ of the high-resolution image, and can be obtained by substituting for the coordinates (0.1, 0.9) of the central location and the pixel size Z of the pixel H₀ in Equation 5.

As described above, a simultaneous equation expressed in Equation 8 can be obtained by assuming that each element ωₕₖ of the predictive coefficient used in Equation 6 is the same as each element of the new predictive coefficient approximated using Equation 4. h of the element ωₕₖ of the predictive coefficient in Equation 6 represents the pixel location of the high-resolution image, and a simultaneous equation including 25 expressions can be obtained since 25 h exist.

$${ω}_{0 , k} ≅ {\sum }_{i = 0}^{n} {\sum }_{j = 0}^{n - i} {w}_{ijk} \frac{1}{{Z}_{x} \times {Z}_{y}} \{ {b}_{0} sin c ( {δ}_{i} {b}_{0} ) - {a}_{0} sin c ( {δ}_{i} {a}_{0} ) \} \cdot \{ {d}_{0} sin c ( {δ}_{j} {d}_{0} ) - {c}_{0} sin c ( {δ}_{j} {c}_{0} ) \} \cdot exp ( - \frac{1}{2} {σ}^{2} ( {δ}_{i}^{2} + {δ}_{j}^{2} ) ) \\ {ω}_{1 , k} ≅ {\sum }_{i = 0}^{n} {\sum }_{j = 0}^{n - i} {w}_{ijk} \frac{1}{{Z}_{x} \times {Z}_{y}} \{ {b}_{1} sin c ( {δ}_{i} {b}_{1} ) - {a}_{1} sin c ( {δ}_{i} {a}_{1} ) \} \cdot \{ {d}_{1} sin c ( {δ}_{j} {d}_{1} ) - {c}_{1} sin c ( {δ}_{j} {c}_{1} ) \} \cdot exp ( - \frac{1}{2} {σ}^{2} ( {δ}_{i}^{2} + {δ}_{j}^{2} ) ) \\ ⋮ \\ {ω}_{23 , k} ≅ {\sum }_{i = 0}^{n} {\sum }_{j = 0}^{n - i} {w}_{ijk} \frac{1}{{Z}_{x} \times {Z}_{y}} \{ {b}_{23} sin c ( {δ}_{i} {b}_{23} ) - {a}_{23} sin c ( {δ}_{i} {a}_{23} ) \} \cdot \{ {d}_{23} sin c ( {δ}_{j} {d}_{23} ) - {c}_{23} sin c ( {δ}_{j} {c}_{23} ) \} \cdot exp ( - \frac{1}{2} {σ}^{2} ( {δ}_{i}^{2} + {δ}_{j}^{2} ) ) \\ {ω}_{24 , k} ≅ {\sum }_{i = 0}^{n} {\sum }_{j = 0}^{n - i} {w}_{ijk} \frac{1}{{Z}_{x} \times {Z}_{y}} \{ {b}_{24} sin c ( {δ}_{i} {b}_{24} ) - {a}_{24} sin c ( {δ}_{i} {a}_{24} ) \} \cdot \{ {d}_{24} sin c ( {δ}_{j} {d}_{24} ) - {c}_{24} sin c ( {δ}_{j} {c}_{24} ) \} \cdot exp ( - \frac{1}{2} {σ}^{2} ( {δ}_{i}^{2} + {δ}_{j}^{2} ) ) \qquad ( 8 )$$

Meanwhile, each element ωₕₖ of the predictive coefficient in Equation 8 corresponds to each element of the predictive coefficient which has been learned beforehand using the method according to the related art described with reference to FIG. 2.

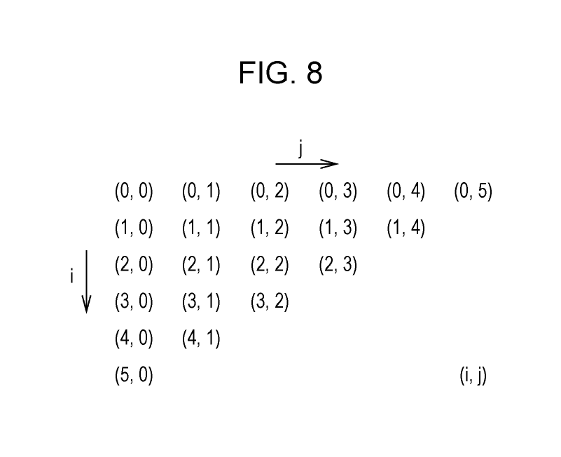

Here, it is assumed that the value of n used in Equations 3, 7, and 8 is set to be 6. Then, the combination of (i,j) in Equations 3, 7, and 8 is determined as expressed in FIG. 8.

As shown in FIG. 8, when n is 6, the value of i is an integral number ranging from 0 to 5. The value of j is an integral number ranging from 0 to 5 when i is 0, the value of j is an integral number ranging from 0 to 4 when i is 1, . . . , the value of j is only 0 when i is 5.

As shown in FIG. 8, when the value of n used in Equations 3, 7, and 8 is set to be 6, the number of combinations of (i,j) is 21. That is, 21 wᵢⱼₖ are unknowns in the simultaneous equation which includes 25 equations expressed in Equation 8.

Therefore, for example, in order to minimize the error terms of the simultaneous equation expressed in Equation 8, 21 wᵢⱼₖ can be drawn using a least-squares method. In this way, 21 wᵢⱼₖ is drawn for every k value.

For example, each of the values of wᵢⱼₖ drawn in this way is stored in the integrated database. In the case of the above-described example, since the number of k is 9 which is the same number as the number of the elements of the predictive tap, 189(=21×9) values of wᵢⱼₖ are stored in the integrated database.

The pixel values of the high-resolution image can be obtained based on the pixel value of the low-resolution image using wᵢⱼₖ stored in the integrated database. Such wᵢⱼₖ is referred to as a coefficient configuration value.

Meanwhile, the coefficient configuration value is classified as a class and stored in the integrated database. That is, the coefficient configuration value, which corresponds to the results of the class classification based on the class tap extracted from the input image, is stored in the integrated database. For example, since each element ωₕₖ of the predictive coefficient used in Equations 7 and 8 has been obtained through the learning beforehand, it is preferable that the class classified in the learning be assigned to the coefficient configuration value.

Here, coefficient configuration values stored in the integrated database will be described in detail while comparing with a case where a predictive coefficient is stored.

A predictive coefficient stored in an image processing apparatus according to the related art is stored in such a way that the predictive coefficient is classified for each class and is assigned to the phase of an output image. For example, when enlargement conversion is performed on a low-resolution image at magnification 5×5 using a predictive tap including 9 pixel values, a predictive coefficient is stored as followed. In this case, it is necessary to consider, for example, 25 phases ranging from a phase 0 to a phase 24 as phases of an output image the pixel value of which will be calculated based on a predictive tap corresponding to a single focus pixel.

The following 225(=9×25) elements are stored as the elements of the predictive coefficient to be multiplied by a predictive tap which centers on a focus pixel classified as a class c1.

The element ω₀₁ to be multiplied by the first element of the predictive tap in order to obtain the phase 0 of the output image, the element ω₀₂ to be multiplied by the second element of the predictive tap in order to obtain the phase 0, . . . , and the element ω₀₉ to be multiplied by the ninth element of the predictive tap in order to obtain the phase 0 are stored.

In the same manner, the element ω₁₁ to be multiplied by the first element of the predictive tap in order to obtain the phase 1 of the output image, the element ω₁₂ to be multiplied by the second element of the predictive tap in order to obtain the phase 1, . . . , and the element ω₁₉ to be multiplied by the ninth element of the predictive tap in order to obtain the phase 1 are stored.

As described above, the first to ninth elements of the predictive tap used to obtain the respective phases 2 to 24 of the output image are also stored.

Thereafter, 225(=9×25) elements are stored as the elements of the predictive coefficient to be multiplied by a predictive tap which centers on a focus pixel classified as a class c2 in the same manner. Therefore, in total, the number of classes×225 elements of the predictive coefficient are stored.

In the embodiment of the present invention, coefficient configuration values stored in the integrated database are classified for each class and are stored in such a way that each of the coefficient configuration values corresponds to the element of a predictive coefficient (or a predictive tap). For example, when enlargement conversion is performed on a low-resolution image at magnification 5×5 using a predictive tap including 9 pixel values, the following coefficient configuration values are stored. Meanwhile, it is assumed that the value of n used in Equations 3, 7 and 8 is 6, and the number of the combination of (i,j) shown in FIG. 8 is 21 as described above.

The following 189 (=21×9) coefficient configuration values are stored as the coefficient configuration values used to calculated the elements of the predictive coefficient to be multiplied by the predictive tap which centers on the focus pixel classified as the class c1.

In order to obtain the pixel (any one of phase 0 to phase 24) of the output image, the coefficient configuration value w₀₀₁ used to calculate the first element of the predictive coefficient, the coefficient configuration value w₀₁₁ used to calculate the first element of the predictive coefficient, . . . , and the coefficient configuration value w₅₀₁ used to calculate the first element of the predictive coefficient are stored.

In the same manner, in order to obtain the pixel (any one of phase 0 to phase 24) of the output image, the coefficient configuration value w₀₀₂ used to calculate the second element of the predictive coefficient, the coefficient configuration value w₀₁₂ used to calculate the second element of the predictive coefficient, . . . , and the coefficient configuration value w₅₀₂ used to calculate the second element of the predictive coefficient are stored.

As described above, the first to 21-th coefficient configuration values used to calculate the respective the third to ninth elements of the predictive coefficient are stored.

Therefore, 189(=21×9) coefficient configuration values are stored as the coefficient configuration values used to calculate the elements of the predictive coefficient to be multiplied by the predictive tap which centers on the focus pixel classified as the class c2 in the same manner. Therefore, the number of classes×189 coefficient configuration values are stored.

As described above, according to the embodiment of the present invention, magnification can be arbitrarily set and the amount of information to be stored is not increased as compared with the related art. Therefore, according to the embodiment of the present invention, image quality conversion processing capable of corresponding to various conversion patterns can be implemented using a simple configuration.

When the pixel value of the high-resolution image is obtained based on the pixel value of the low-resolution image using the above-described integrated database, the coordinate R, the pixel size Z, and the Gaussian parameter σ are specified based on the resolution of the input image (low-resolution image) and the number of pixels of the high-resolution image to be output.

Thereafter, the element Dₖ(R,Z,σ) of the new predictive coefficient can be obtained by substituting for the specified coordinate R, pixel size Z, and Gaussian parameter σ in Equation 4 as parameters and substituting for the coefficient configuration value wᵢⱼₖ read from the integrated database in Equation 4.

The pixel value of the high-resolution image can be obtained by performing a product-sum operation on each of the elements of the new predictive coefficient obtained as described above and each of the elements of the predictive tap extracted from the input image.

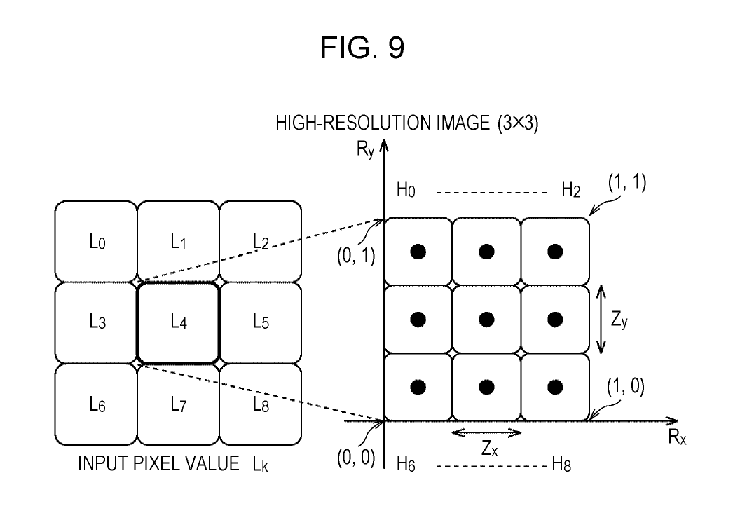

Description will be performed in detail with reference to FIG. 9. FIG. 9 is a view illustrating the example in which enlargement conversion is performed on the low-resolution image at magnification 3×3.

9 rectangles shown in the left side of the drawing represent the tap of the input image (low-resolution image). In this example, the pixels of the input image are represented using the respective rectangles indicated by reference symbols L₀ to L₈. Further, the focus pixel of the input image is the pixel represented by the rectangle indicated by reference symbol L₄ in the drawing, and the pixel values of the 9(=3×3) pixels centering on the focus pixel constitute a tap.

Furthermore, in this example, 9(=3×3) pixels of the high-resolution image shown at the right side of the drawing are generated in order to correspond to the focus pixel (the rectangle indicated by reference symbol L₄) of the input image. The 9 rectangles shown at the right side of FIG. 9 represent the respective pixels of the high-resolution image which are generated in order to correspond to the focus pixel. Meanwhile, a black dot shown in each rectangle represents the central location of each pixel. Further, the uppermost left pixel in the drawing is the pixel H₀, and a reference symbol is attached in turn, so that the lowermost right pixel in the drawing is the pixel H₈.

Meanwhile, the coordinates of the four corners of the pixel group of the high-resolution image at the right side of FIG. 9 are represented as (0,1), (1, 1), (0,0) and (1, 0) for the sake of convenience. Further, with respect to the high-resolution image in the drawing, 9(=3×3) pixels of the high-resolution image are generated on a plane which corresponds to one pixel of the low-resolution image, so that both the x component and y component of the pixel size Z are 0.33(=⅓). Therefore, the coordinates of the central location of the pixel H₀ can be specified as (⅙,⅚). In the same manner, the coordinates of the central location of the pixel H₁ are specified as ( 3/6,⅚), . . . , and the coordinates of the central location of the pixel H₈ are specified as (⅚,⅙).

In this case, each element ω₀ₖ of the predictive coefficient which is necessary to obtain the value of the pixel H₀ of the high-resolution image can be obtained using Equation 9 with Equation 4.

$${ω}_{0 , k} ≅ {\sum }_{i = 0}^{n} {\sum }_{j = 0}^{n - i} {w}_{ijk} \frac{1}{{Z}_{x} \times {Z}_{y}} \{ {b}_{0} sin c ( {δ}_{i} {b}_{0} ) - {a}_{0} sin c ( {δ}_{i} {a}_{0} ) \} \cdot \{ {d}_{0} sin c ( {δ}_{j} {d}_{0} ) - {c}_{0} sin c ( {δ}_{j} {c}_{0} ) \} \cdot exp ( - \frac{1}{2} {σ}^{2} ( {δ}_{i}^{2} + {δ}_{j}^{2} ) ) \qquad ( 9 )$$

Meanwhile, although each element of the predictive coefficient which is necessary to obtain the value of the pixel of the high-resolution image is represented by ωₖ here, the element is the same as each element Dₖ of the new predictive coefficient expressed in Equation 4. Therefore, it can be restated that each element of the new predictive coefficient can be calculated using Equation 9.

If each coefficient configuration value wᵢⱼₖ which is read from the integrated database is substituted for while the pixel size Z and the Gaussian parameter σ are substituted for in Equation 9 as parameters, the value of each element ω₀ₖ of the predictive coefficient is calculated. At this time, all the coefficient configuration values wᵢⱼₖ stored in the integrated database are used regardless of the magnification of enlargement conversion. For example, when 189(=21×9) coefficient configuration values are stored in the integrated database as described above, 21 coefficient configuration values are substituted for in Equation 9, respectively.

For example, 21 coefficient configuration values are substituted for in Equation 9 in order to calculate the value of the element ω₀₀, other 21 coefficient configuration values are substituted for in Equation 9 in order to calculate the value of the element ω₀₁, and another 21 coefficient configuration values are substituted for in Equation 9 in order to calculate the value of the element ω₀₂. In this way, 189 coefficient configuration values are used to calculate the elements ω₀₀ to ω₀₈.

Meanwhile, in the same manner as in the case where description has been performed with reference to FIG. 7, a₀, b₀, c₀, and d₀ in Equation 9 represent the respective coordinates of the four corners of a rectangle plane corresponding to the pixel H₀ of the high-resolution image, and can be obtained by substituting for the coordinates of the central location and the pixel size Z of the pixel H₀ in Equation 5.

In this way, the value of each element ω₀ₖ of 81(=9×9) predictive coefficients is obtained, and the product-sum operation is performed on each element of the predictive coefficients and each element of the predictive tap extracted from the input image, thereby obtaining the pixel value of each pixel ranging from pixel H₀ to pixel H₈ of the high-resolution image.

For example, when the pixel value of the pixel H₀ of the high-resolution image is obtained, the product of the pixel value of the pixel L₀ of the low-resolution image and each element ω₀₀ of the predictive coefficient is calculated, the product of the pixel value of the pixel L₁ of the low-resolution image and each element ω₀₁ of the predictive coefficient is calculated, . . . , and the product of the pixel value of the pixel L₈ of the low-resolution image and each element ω₀₈ of the predictive coefficient is calculated. Thereafter, the sum of the values obtained through the product is calculated, thereby obtaining the pixel value of the pixel H₀ of the high-resolution image (the operation is the same as the operation expressed in Equation 6).

Each of the pixel values of the pixels H₀ to H₈ of the high-resolution image can be obtained based on the pixel values (predictive tap) of the pixels L₀ to L₈ of the low-resolution image by performing such operation 9 times (from the pixel H₀ to the pixel H₈). Thereafter, a predictive tap which includes the focus pixel of the input image as a separate pixel is newly extracted, and the separate 9 pixel values of the high-resolution image is calculated based on the predictive tap. The output image in which enlargement conversion has been performed on the input image at magnification of 3×3 is generated finally through the repetition of the operation on the pixel values.

Meanwhile, the blur of the output image (high-resolution image) can be adjusted by adjusting the value of Gaussian parameter σ in Equation 9. For example, a blurred image is output when the value of Gaussian parameter σ is large, and a sharp image, which is hardly blurred, is output when the value of Gaussian parameter σ is small.

Further, although an example in which a Gaussian model has been used as a model (condensing model) representing condensing properties has been described here, a circular model can be used instead of the Gaussian model.

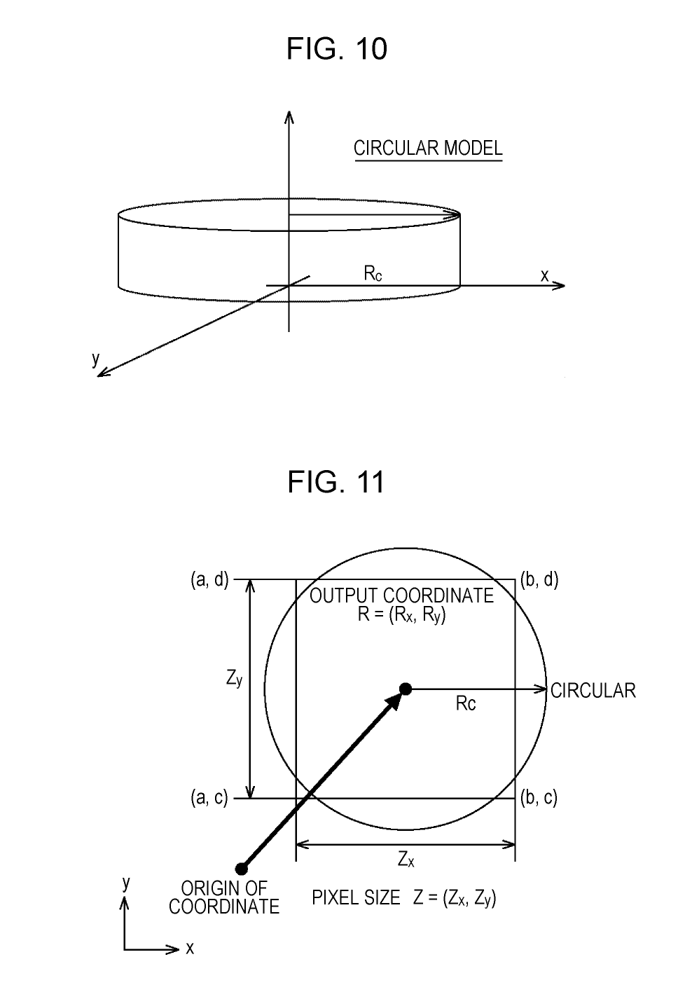

With respect to the circular model, a weight coefficient is uniform in the circle having the radius R_{c} from a center, unlike, for example, the Gaussian model shown in FIG. 5. FIG. 10 is a 3-dimensional space diagram illustrating the weight coefficient of the circular model.

Further, when the circular model is used as the condensing model, FIG. 6 is reconfigured as shown in FIG. 11. In FIG. 11, the radius of a circle in the drawing is the circular radius R_{c}.

When the circular model is used as the condensing model, Dₖ in Equation 2 is approximated using Equation 10 by using the coordinate R of the center of the pixel of the high-resolution image, the pixel size Z of the high-resolution image, and the circular radius R_{c} of the condensing model S(r) as variables.

$$\begin{matrix}{D}_{k} ( R , Z , {R}_{c} ) = {\int }_{- ∞}^{∞} {\int }_{- ∞}^{∞} S ( r , Z , {R}_{c} ) \cdot {W}_{k} ( R + r ) d {r}_{x} d {r}_{y} \\ ≅ {\sum }_{i = 0}^{n} {\sum }_{j = 0}^{n - i} {w}_{ijk} \frac{1}{{Z}_{x} {Z}_{y}} \{ b sin c ( {δ}_{i} b ) - a sin c ( {δ}_{i} a ) \} \cdot \\ \{ d sin c ( {δ}_{j} d ) - c sin c ( {δ}_{j} c ) \} \cdot \\ \frac{1}{{R}_{c}^{2} ( {δ}_{i}^{2} + {δ}_{j}^{2} )} {\int }_{0}^{{R}_{c}^{2} ( {δ}_{i}^{2} + {δ}_{j}^{2} )} {J}_{0} ( \sqrt{r} ) d r\end{matrix} \qquad ( 10 )$$

Meanwhile, function J₀ (x) in Equation 10 is a zero-order vector function.

A coefficient configuration value wᵢⱼₖ in Equation 10 may be obtained by assuming that each element Dₖ(R,Z,Rc) of the new predictive coefficient expressed in Equation 10 is the same as, for example, each element of the predictive coefficient learned using the method according to the above-described related art with reference to FIG. 2.

Additionally, a pixel integral model may be used as the condensing model. The pixel integral model is a model defined using Equation 11. This model supposes a rectangle pixel, and Zx and Zy in Equation 11 respectively represent the length of a pixel in the horizontal direction and the length of a pixel in the vertical direction.

$$\begin{matrix}S ( r ) = 1 / {Z}_{x} {Z}_{y} ( - {z}_{x} / 2 \leq {r}_{x} \leq {z}_{x} / 2 and - {z}_{y} / 2 \leq {r}_{y} \leq {z}_{y} / 2 ) \\ = 0 ( otherwise )\end{matrix} \qquad ( 11 )$$

Meanwhile, the Gaussian model is defined using Equation 12.

S(r)=(1/2πσ²)exp(−rₓ²/2σ²)exp(−r_{y}²/2σ²) (12)

Furthermore, the circular model is defined using Equation 13.

$$\begin{matrix}S ( r ) = 1 / π {R}_{c}^{2} ( {r}_{x}^{2} + {r}_{y}^{2} \leq {R}_{c}^{2} ) \\ = 0 ( otherwise )\end{matrix} \qquad ( 13 )$$

Herewith, even though the condensing model is substituted for by other models, enlargement conversion processing according to the embodiment of the present invention can be performed.

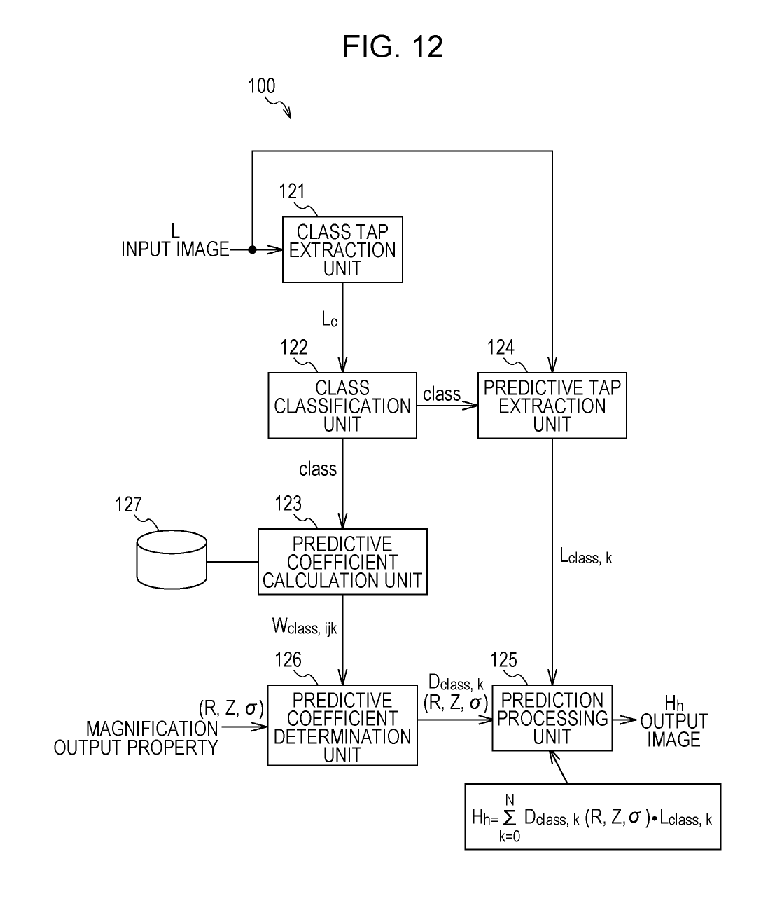

FIG. 12 is a block diagram illustrating an example of the configuration of an image processing apparatus 100 according to an embodiment of the present invention. The image processing apparatus 100 shown in the drawing is configured in such a way that, for example, a low-resolution image L is input as an input image, a high-resolution H pixel Hₕ is generated based on the predetermined pixel of the image L, and the pixel Hₕ is output as an output image. That is, image enlargement conversion is performed by the image processing apparatus 100.

The input image is provided to a class tap extraction unit 121, and a focus pixel is set. The class tap extraction unit 121 is configured to, for example, extract a class tap L_{c} which includes the value of a focus pixel and the values of neighboring pixels around the focus pixel. The class tap corresponds to, for example, one of several to dozens of dimensional vectors.

A class classification unit 122 classifies the corresponding class tap as a predetermined class by analyzing the extracted class tap, and determines the class.

A predictive tap extraction unit 124 extracts a predictive tap from the input image, the predictive tap being determined beforehand in correspondence with the class determined by the class classification unit 122. The predictive tap L_{class, k} includes the value of a focus pixel and the values of neighboring pixels around the focus pixel, and is configured as a vector that includes k elements in this example.

Meanwhile the class tap extraction unit 121, the class classification unit 122, and the predictive tap extraction unit 124 are the same as the respective class tap extraction unit 21, the class classification unit 22, and the predictive tap extraction unit 24 of the image processing apparatus 10 according to the related art illustrated in FIG. 1.

As described above, in the embodiment of the present invention, each element ωₕₖ of the predictive coefficient in Equation 8 corresponds to, for example, each element of the predictive coefficient which has been learned beforehand using the method according to the related art which has been described with reference to FIG. 2, and are used to solve the simultaneous equation in Equation 8. Therefore, for example, when the coefficient configuration value wᵢⱼₖ, obtained in such a way that each element of the predictive coefficient used in the image processing apparatus 10 according to the related art shown in FIG. 1 is substituted for in Equation 8 and the simultaneous equation is solved, is stored in the integrated database, class classification and tap extraction may be performed like the image processing apparatus 10.

For example, when the class tap extraction unit 21 obtains a class tap including 25 pixel values, the class classification unit 22 performs class classification using a method A and the predictive tap extraction unit 24 extracts a predictive tap including 9 pixel values, the class tap extraction unit 121 obtains the class tap including 25 pixel values, the class classification unit 122 performs class classification using the method A, and the predictive tap extraction unit 124 extracts the predictive tap including 9 pixel values.

Further, for example, when the class tap extraction unit 21 obtains a class tap including 9 pixel values, the class classification unit 22 performs class classification using a method B and the predictive tap extraction unit 24 extracts a predictive tap including 25 pixel values, the class tap extraction unit 121 obtains the class tap including 9 pixel values, the class classification unit 122 performs class classification using the method B, and the predictive tap extraction unit 124 extracts the predictive tap including 25 pixel values.

The predictive coefficient determination unit 123 is configured to read a coefficient configuration value, which is necessary to generate the pixel of the pixel location h of the output image corresponding to the focus pixel of the input image and which corresponds to the class determined by the class classification unit 122, from an integrated database 127. In this example, the coefficient configuration value w_{class, ijk} is read by the predictive coefficient determination unit 123 and provided to a predictive coefficient calculation unit 126.

Thereafter, the predictive coefficient calculation unit 126 calculates each element of a new predictive coefficient based on the coefficient configuration value provided from the predictive coefficient determination unit 123, the coordinate R, the pixel size Z and the Gaussian parameter σ. At this time, for example, the above-described operation is performed with reference to Equation 4.

Meanwhile, the coordinate R, the pixel size Z, and the Gaussian parameter σ are specified beforehand based on the magnification of the enlargement conversion and the properties of the output image.

The prediction processing unit 125 is configured to generate and output a predetermined pixel Hₕ of the high-resolution image by performing a product-sum operation on each element of the predictive tap provided from the predictive tap extraction unit 124 and each element of the new predictive coefficient provided from the predictive coefficient calculation unit 126.

In this manner, image enlargement conversion according to the embodiment of the present invention is performed.

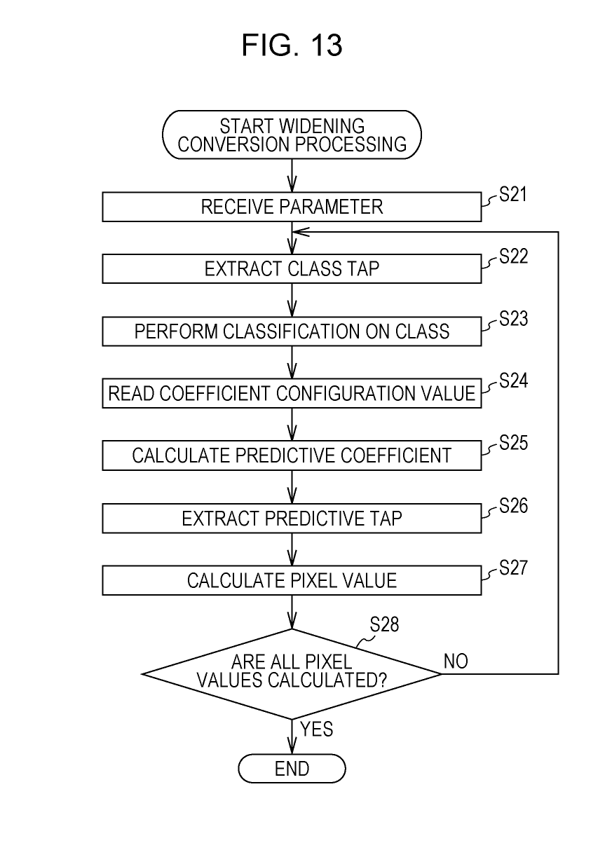

Next, an example of enlargement conversion processing performed by the image processing apparatus 100 of FIG. 12 will be described with reference to the flowchart of FIG. 13. This processing is performed, for example, when an instruction is given such that a low-resolution image L is received as an input image, the pixels of high resolution H are generated based on the predetermined pixel of the image L, and the pixels of high resolution image are output as an output image.

The predictive coefficient calculation unit 126 receives the input of a parameter at step S21. Here, the parameter includes, for example, the coordinate R of the pixel value of the high-resolution image to be generated, the pixel size Z, and the Gaussian parameter σ. Meanwhile, the coordinate R, the pixel size Z and the Gaussian parameter σ are, for example, specified by a user based on magnification of the enlargement conversion and the properties of the output image.

The class tap extraction unit 121 extracts, for example, a class tap, including the value of a focus pixel and the values of the neighboring pixels around the focus pixel, from the input image at step S22.

The class classification unit 122 analyzes the class tap extracted at the processing of step S22, thereby classifying the corresponding class tap as a predetermined class and determining the class at step S23.

The predictive coefficient determination unit 123 reads a coefficient configuration value from the integrated database 127 at step S24. The coefficient configuration value is necessary to generate the pixels which correspond to the focus pixel of the input image and located at the predetermined pixel location of the output image, and the coefficient configuration value corresponds to the class determined at the processing of step S23.

The predictive coefficient calculation unit 126 calculates each element of a new predictive coefficient based on the coefficient configuration value provided from the predictive coefficient determination unit 123 at the processing of step S24 and based on the coordinate R, the pixel size Z, and the Gaussian parameter σ which are received at step S21, at step S25. Here, the above-described operation is performed, for example, with reference to Equation 4.

The predictive tap extraction unit 124 extracts the predictive tap, which has been predetermined to correspond to the class determined by the class classification unit 122 at step S23, from the input image at step S26. The predictive tap includes the value of the focus pixel and the values of the neighboring pixels around the focus pixel.

Meanwhile, the extraction of the predictive tap performed by the predictive tap extraction unit 124 may be performed after the processing at step S23 and before the processing at step S24, or may be performed before the processing at step S25.

The prediction processing unit 125 performs a product-sum operation on each element of the predictive tap, provided from the predictive tap extraction unit 124 at step S26, and each element of the new predictive coefficient, provided from the predictive coefficient calculation unit 126 at step S25, at step S27. Therefore, the values of the predetermined pixels of an image (high-resolution image) obtained after enlargement conversion has been performed are calculated, thereby generating the pixels.

It is determined whether the values of all the pixels of the output image are calculated or not at step S28.

When it is determined that not all of the values of the pixels are calculated at step S26, the process returns to step S22 and the process is repeatedly performed therefrom.

When it is determined that the values of all the pixels of the output image are operated at step S26, the process ends.

The enlargement conversion processing is performed in this manner.

Herewith, according to the embodiment of the present invention, enlargement conversion can be freely performed at arbitrary magnification.

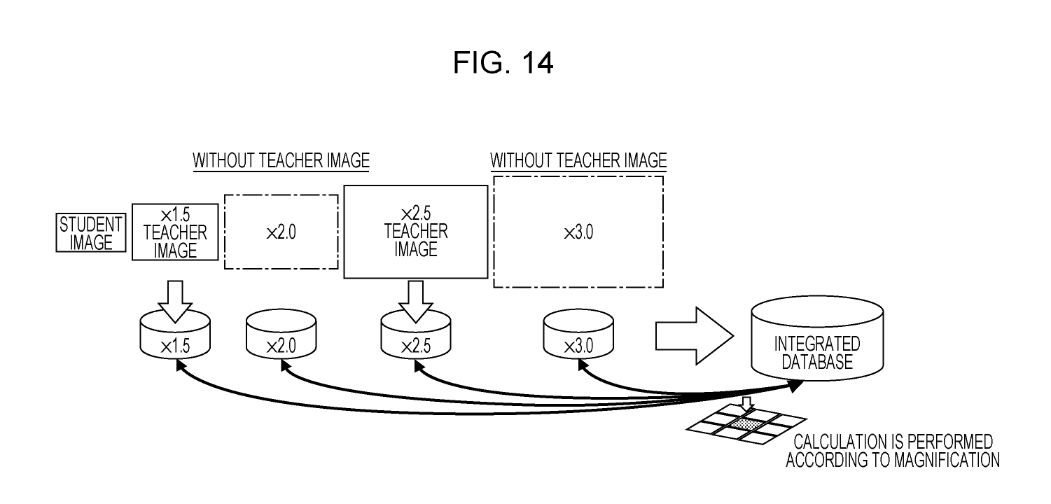

For example, if combinations of a student image and a teacher image corresponding to respective magnification of 1.5 times (×1.5) and 2.5 times (×2.5) are prepared as shown in FIG. 14 and predictive coefficients are learned based on the learning pair thereof, enlargement conversion can be performed at magnification of 2 times and 3 times.

Meanwhile, FIG. 14 illustrates the case where the learning pairs of a student image and a teacher image corresponding to the respective magnification of 2 times (×2.0) and 3 times (×3.0) are not prepared. Further, the drawing illustrates that, even in this case, if information stored in the integrated database is used, predictive coefficients corresponding to the respective magnification of 2 times and 3 times can be generated.

That is, if the operation in Equation 4 is performed using the coefficient configuration value stored in the integrated database, the predictive coefficients corresponding to the respective magnification of 2 times and magnification of 3 times which have not been actually learned can be simply generated. Therefore, even when a learning pair is hardly prepared, for example, as in enlargement conversion using ultra-high magnification, enlargement conversion can be performed using the image processing apparatus 100 according to the embodiment of the present invention.

Further, if the value of n in Equation 3 is sufficiently large, the image quality of an output image generated through the enlargement conversion processing is comparable to the image quality of an image on which enlargement conversion is performed using a predictive coefficient obtained through direct learning.

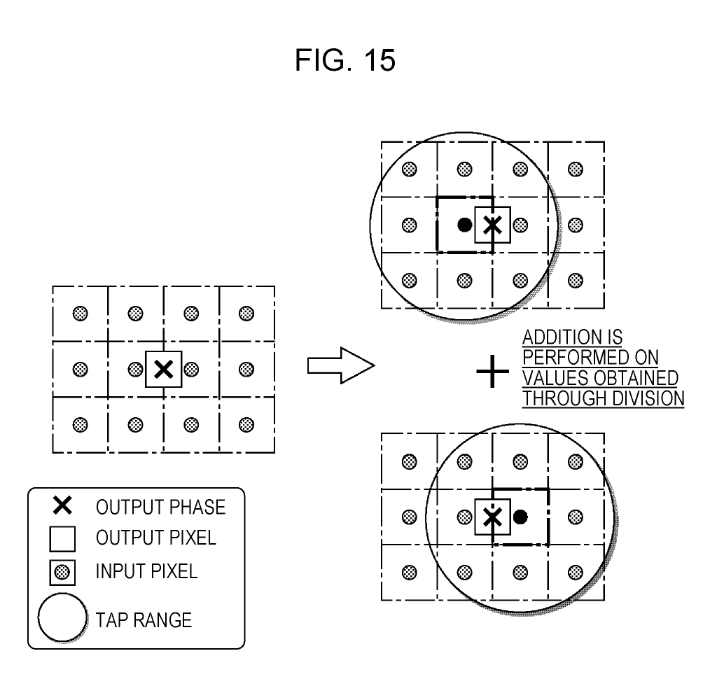

Furthermore, according to the embodiment of the present invention, an output image can be obtained, the image quality of which is higher than that of an image on which enlargement conversion is performed according to the related art. FIG. 15 is a view illustrating a method of implementing high-image quality enlargement conversion according to an embodiment of the present invention.

In FIG. 15, an input image is represented using 12(=4×3) rectangles for the sake of convenience. White rectangles represent the pixels (input pixels) of a low-resolution image, and circles in the middle of the respective white rectangles represent the centers of the pixels. Further, each of relatively small-area rectangles shown in the centers in the drawing represents the pixel (output pixel) of a high-resolution image. Each symbol× shown in the middle of the output pixel represents the central location of the output pixel. The coordinates (output phase) of the pixel location (for example, a predetermined pixel Hₕ of the high-resolution image) of the output image to be specified when the enlargement conversion processing is performed corresponds to the location of the symbol × in the drawing. In this example, with respect to the output phase, the location in the horizontal direction and the location in the vertical direction are configured to be the center of the image.

Here, as shown in FIG. 15, when the location of the output phase in the horizontal direction is in the middle of a second column and a third column from the left side, a problem is how to specify the locations of pixels used as the pixel values of a predictive tap. For example, in the enlargement conversion processing performed by the image processing apparatus 10 according to the related art, the pixel value of an output pixel is obtained using a tap (predictive tap) which includes 9 pixel values corresponding to 3 columns from the left of the input pixels. The pixel value of the output pixel may be obtained using a tap which includes 9 pixel values corresponding to 3 columns from the right of the input pixels.

That is, the pixel values of the input image, which are near by the output phase, are generally used as a tap since it is determined that input pixels near the output phase are most highly correlated. However, when the output phase locates in the middle of input pixels, the output pixel value is hardly uniquely specified. In this case, even though any one is selected based on a predetermined reference, for example, a tap including 9 pixel values corresponding to 3 columns from the left or a tap including 9 pixel values corresponding to 3 columns from the right, there is no assurance that the output pixel value can be calculated with a high degree of accuracy.

According to the embodiment of the present invention, the area of the output pixel is divided into halves, so that the pixel value corresponding to the left half of the output pixel can be calculated using a tap including 9 pixel values corresponding to 3 columns from the left of the input pixels and the pixel value corresponding to the right half of the output pixel can be calculated using the tap including 9 pixel values corresponding to 3 columns from the right of the input pixels. Therefore, the pixel value of the output pixel can be obtained by adding the calculated left half pixel value to the right half pixel value.

That is, in the enlargement conversion processing according to the related art, the area of the output pixel is not considered and the pixel value of an output phase which is the center of the output pixel is calculated, so that it is hard to divide an output pixel and calculate the pixel value. That is, although the pixel actually has a predetermined area, the enlargement conversion processing according to the related art calculates only the pixel value of a point corresponding to the location of reference symbol× in the drawing.

On the other hand, in the embodiment of the present invention, the calculation of a predictive coefficient is performed while considering that the pixel value of the high-resolution image is obtained in such a way that the pixel values of the infinite-resolution image are integrated based on condensing properties as described above, so that the area of the output pixel can be freely set. For example, the coordinate R and the pixel size Z of the parameter received at step S21 of FIG. 13 are properly set, so that the pixel value of the output pixel divided as shown in FIG. 15 can be calculated.

For example, when an output phase is located in the middle of the pixel columns of the input pixels as shown in FIG. 15, the pixel value of the output pixel is hardly calculated with a high accuracy even though pixels corresponding to the left 3 columns of the input pixels are used as a tap or pixels corresponding to the right 3 columns of the input pixels are used as a tap.

According to the embodiment of the present invention, each of the pixel values can be calculated by dividing an output pixel when the output phase is located in the middle of the pixel columns of the input pixels, so that enlargement conversion of higher image quality can be implemented.

Meanwhile, although the example in which an output pixel is divided into two parts has been described in FIG. 15, the output pixel may be divided into four parts as a matter of course. Herewith, division is performed on an output pixel if necessary and the pixel values of the divided output pixel are calculated, and the pixel value of the output pixel is finally calculated by adding the divided pixel values, so that enlargement conversion with higher image quality can be implemented.

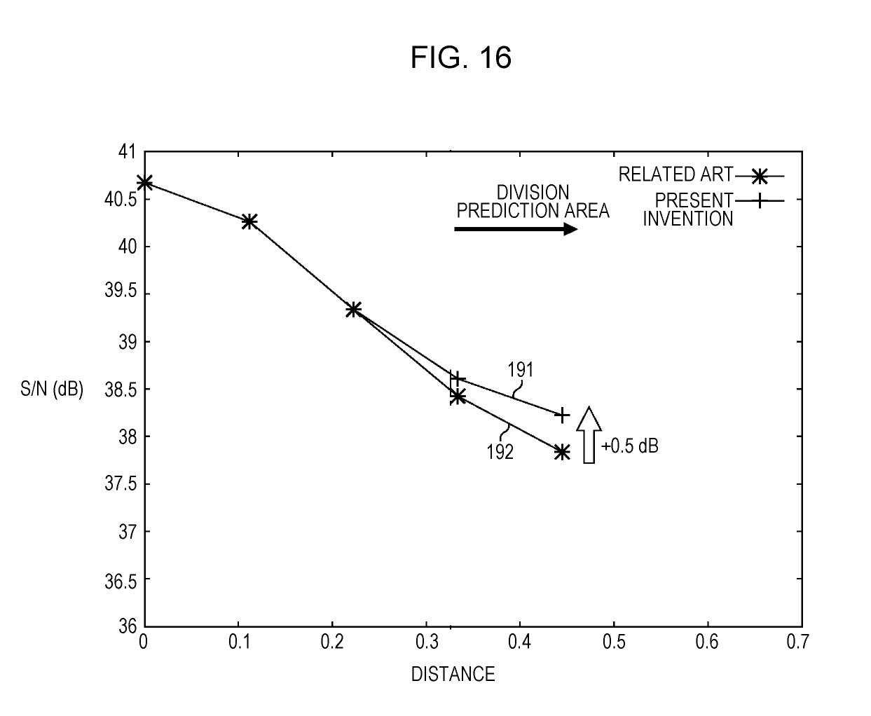

FIG. 16 is a view illustrating the effect obtained when enlargement conversion processing is performed according to the method described above with reference to FIG. 15.

In FIG. 16, a horizontal axis represents the distance between the center of an input pixel and an output phase, and a vertical axis represents the S/N ratio of the pixel value of the output pixel. A line 191 in the drawing represents variation in the S/N ratio of the pixel value of the output pixel, which is obtained through the enlargement conversion processing according to the embodiment of the present invention, that is, according to the enlargement conversion processing which uses the above-described method with reference to FIG. 15. A line 192 in the drawing represents variation in the S/N ratio of the pixel value of the output pixel, which is obtained through the enlargement conversion processing according to the related art.

Meanwhile, in the case of the enlargement conversion processing according to the embodiment of the present invention, the distance (about 0.32) which corresponds to the location represented by a dotted line in the vertical direction of the drawing is set as a boundary. When the distance is larger than the boundary, division is performed on the output pixel, the pixel values of the resulting output pixels are calculated, the pixel values of the resulting output pixels are added, and the pixel value of the output pixel is finally calculated.

As shown in FIG. 16, when the line 191 is compared with the line 192, the S/N ratio represented by the line 191 is high (image quality is improved) as the output phase is separated from the center of the input pixels. In this example, when the distance between the output phase and the center of the input pixels is about 0.45, it can be known that an image quality of about 5 dB is improved, as compared with the related art.

As described above, according to the embodiment of the present invention, image quality can be improved and various conversion patterns can be dealt using a simple configuration.

Although the case where resolution conversion processing is performed according to the embodiment of the present invention has been described above as an example, the embodiment of the present invention can be applied to another image quality conversion processing. For example, when high image quality processing, such as blur removal processing or noise removal processing, is performed, the embodiment of the present invention can be applied thereto. That is, according to the embodiment of the present invention, for example, a predictive coefficient can be calculated using the integrated database regardless of the degree of blur and the size of noise.

Therefore, the above-described enlargement conversion processing can be referred to as an example of high image quality processing which is performed by the image processing apparatus 100 described above with reference to FIG. 12.

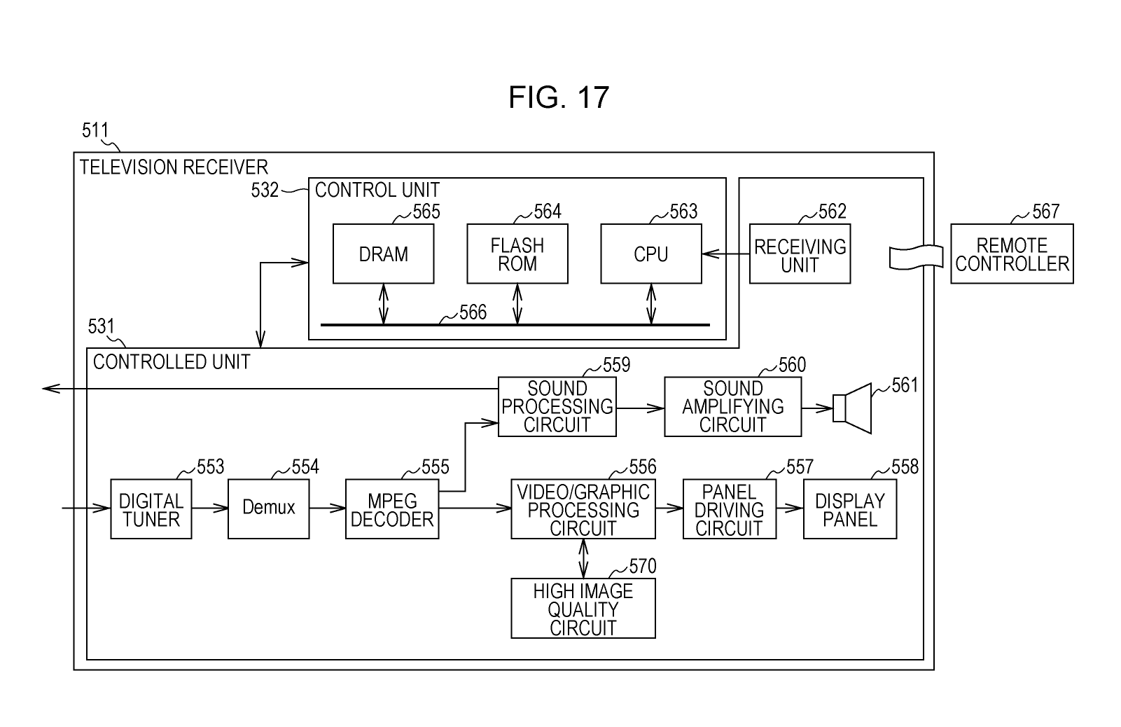

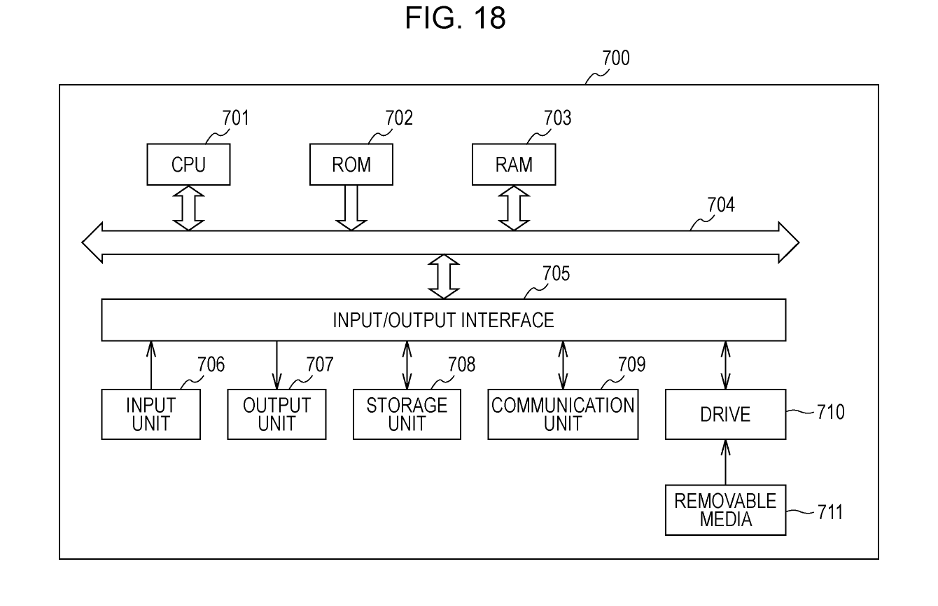

The image processing apparatus 100 described above with reference to FIG. 12 can be mounted on, for example, a television receiver as a high image quality circuit. FIG. 17 is a block diagram illustrating an example of the configuration of a television receiver 511 on which the image processing device described above with reference to FIG. 12 has been mounted.

The television receiver 511 in the drawing includes a controlled unit 531 and a control unit 532. The controlled unit 531 implements the various functions of the television receiver 511 under the control of the control unit 532.

The controlled unit 531 includes a digital tuner 553, a demultiplexer (Demux) 554, a Moving Picture Expert Group (MPEG) decoder 555, a video•graphic processing circuit 556, a panel driving circuit 557, a display panel 558, a sound processing circuit 559, a sound amplifying circuit 560, a speaker 561, and a receiving unit 562. Further, the control unit 532 includes a Central Processing Unit (CPU) 563, a flash ROM 564, a Dynamic Random Access Memory (DRAM) 565, and an internal bus 566.

The digital tuner 553 processes a television broadcasting signal input from an antenna terminal (not shown), and provides predetermined Transport Stream (TS) corresponding to a channel selected by a user to the demultiplexer 554.

The demultiplexer 554 extracts partial TS (the TS packet of a video signal and the TS packet of a sound signal) corresponding to the channel selected by the user from the TS provided from the digital tuner 553, and provides the extracted partial TS to the MPEG decoder 555.

Further, the demultiplexer 554 takes out Program Specific Information/Service Information (PSI/SI) from the TS provided from the digital tuner 553, and provides the PSI/SI to the CPU 563. A plurality of channels are multiplexed in the TS provided from the digital tuner 553. The demultiplexer 554 can extract the partial TS of an arbitrary channel from the TS by obtaining information about the Packet ID (PID) of an arbitrary channel from the PSI/SI (Program Association Table (PAT)/Program Map Table (PMT)).

The MPEG decoder 555 performs decoding processing on a video Packetized Elementary Stream (PES) packet, including the TS packet of the video signal provided from the demultiplexer 554, and provides a video signal obtained based on the results of the decoding processing to the video•graphic processing circuit 556. Further, the MPEG decoder 555 performs decoding processing on a sound PES packet, including the TS packet of a sound signal provided from the demultiplexer 554, and provides a sound signal obtained based on the results of the decoding processing to the sound processing circuit 559.

The video•graphic processing circuit 556 performs scaling processing and graphic data superposition processing on the video signal provided from the MPEG decoder 555 if necessary, and then provides the results to the panel driving circuit 557.

The video•graphic processing circuit 556 is connected to the high image quality circuit 570, and high image quality processing is performed before the video•graphic processing circuit 556 provides the video signal to the panel driving circuit 557.

The high image quality circuit 570 is configured to have the same configuration as the image processing apparatus described above with reference to FIG. 12, and to perform the enlargement conversion processing, described above with reference to FIG. 13, as the high image quality processing on the image data obtained from the video signal provided from the MPEG decoder 555.

The panel driving circuit 557 drives the display panel 558 and displays video based on the video signal provided from the video•graphic processing circuit 556. The display panel 558 includes, for example, a Liquid Crystal Display (LCD) or a Plasma Display Panel (PDP).

The sound processing circuit 559 performs necessary processing such as Digital to Analog (D/A) conversion on the sound signal provided from the MPEG decoder 555, and provides the resulting signal to the sound amplifying circuit 560.

The sound amplifying circuit 560 amplifies an analog sound signal provided from the sound processing circuit 559 and provides the resulting signal to the speaker 561. The speaker 561 outputs sound in response to the analog sound signal provided from the sound amplifying circuit 560.

The receiving unit 562 receives, for example, an infrared remote control signal transmitted from the remote controller 567 and provides the received signal to the CPU 563. A user can operate the television receiver 511 by operating the remote controller 567.

The CPU 563, the flash ROM 564 and the DRAM 565 are connected to each other through an internal bus 566. The CPU 563 controls the operation of each of the units of the television receiver 511. The flash ROM 564 houses control software and stores data. The DRAM 565 is included in the work area of the CPU 563. That is, the CPU 563 starts software by laying out the software and data read from the flash ROM 564 on the DRAM 565, and controls each of the units of the television receiver 511.

As described above, the embodiment of the present invention can be applied to a television receiver.

Meanwhile, the above-described series of processing can be performed using both hardware and software. When the above-described series of processes is performed using software, a program included in the software is installed on a computer, which is integrated into dedicated hardware, from a network or recording medium. Further, various programs are installed on, for example, a general personal computer 700 shown in FIG. 18, which can execute various types of functions, from a network or recording medium.

In FIG. 18, a CPU 701 performs various types of processing based on a program stored in ROM 702 or a program loaded to RAM 703 from a storage unit 708. Data necessary for the CPU 701 to process various types of processing is appropriately stored in the RAM 703.

The CPU 701, the ROM 702, and the RAM 703 are connected to each other through a bus 704. Further, an input/output interface 705 is also connected to the bus 704. The input/output interface 705 is connected to an input unit 706 including a keyboard and a mouse, a display including Liquid Crystal display (LCD), and an output unit 707 including s speaker. Further, the input/output interface 705 is connected to a storage unit 708 including hard disk, a communication unit 709 including a network interface card, such as a modem or a Local Area Network (LAN) card. The communication unit 709 performs communication processing via a network including the Internet.

A drive 710 is also connected to the input/output interface 705 if necessary, so that removal media 711, such as a magnetic disk, an optical disc, a magneto-optical disc, or semiconductor memory, is appropriately mounted thereon. Therefore, a computer program read from the removable media is installed in the storage unit 708 if necessary.

When the above-described series of processing is performed using software, a program included in the corresponding software is installed from a network, such as the Internet, or a recording medium including the removable media 711.

Meanwhile, the recording medium includes a magnetic disk (including a floppy disk (registered trademark)) which stores programs, an optical disc (including Compact Disc-Read Only Memory (CD-ROM), a Digital Versatile Disc (DVD)) and a magneto-optical disc (including a Mini-Disc (MD, registered trademark)), which are distributed in order to deliver a program to a user aside from the main body of the apparatus shown in FIG. 18. Further, the recording medium not only includes the removable media 711 including semiconductor memory but also includes a hard disk included in the ROM 702 or a storage unit 708, in which a program is recorded, and delivered to the user while being mounted in the main body of the apparatus.

Meanwhile, the above-described series of processing according to the embodiment of the present invention includes not only processing performed in a time-oriented manner according to the described order but also processing performed in a paratactic or individual manner even though processing is not necessarily performed in the time-oriented manner.

The present application contains subject matter related to that disclosed in Japanese Priority Patent Application JP 2010-076303 filed in the Japan Patent Office on Mar. 29, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
parameter input means for receiving a parameter including an output phase which corresponds to coordinates of an output pixel, a size of the output pixel, and a variable used for a condensing model;
tap extraction means for extracting a tap including a pixel value of a focus pixel which corresponds to the output phase of an input image and pixel values of neighboring pixels of the focus pixel;
predictive coefficient calculation means for calculating a predictive coefficient to be multiplied by each of elements of the tap using the parameter and a coefficient configuration value stored beforehand; and
pixel value calculation means for calculating a value of the output pixel by performing a product-sum operation of the calculated predictive coefficient and each of the elements of the tap.

2. The image processing apparatus according to claim 1, further comprising a database for storing the coefficient configuration value,
wherein the database stores the coefficient configuration value while the coefficient configuration value corresponds to information used to identify the elements of the tap.

3. The image processing apparatus according to claim 2 further comprising a class classification means for classifying a peripheral image of the focus pixel of the input image as one of a plurality of classes using a predetermined method,
wherein the database stores the coefficient configuration value for each class.

4. The image processing apparatus according to claim 3,
wherein an output image including the output pixel is an image which has a resolution higher than that of the input image.

5. The image processing apparatus according to claim 4,
wherein the size of the output pixel which is received as the parameter is determined based on the resolution of the output image.

6. The image processing apparatus according to claim 5,
wherein a value, which is obtained in such a way that values of a plurality of pixels of an infinite-resolution image having a resolution higher than that of the output image are integrated according to condensing properties represented by the condensing model, is approximated as the value of the output pixel,
wherein the predictive coefficient is described using a function including the parameter and the coefficient configuration value, and
wherein the database stores a predictive coefficient learned beforehand using a high resolution teacher image and a lower resolution student image, and stores the coefficient configuration value obtained based on the function.

7. The image processing apparatus according to claim 1,
wherein the condensing model is a Gaussian model.

8. The image processing apparatus according to claim 1,
wherein the condensing model is a circular model.

9. An image processing method comprising the steps of:
allowing parameter input means for receiving a parameter including an output phase which corresponds to coordinates of an output pixel, a size of the output pixel, and a variable used for a condensing model;
allowing tap extraction means for extracting a tap including a pixel value of a focus pixel which corresponds to the output phase of an input image and pixel values of neighboring pixels of the focus pixel;
allowing predictive coefficient calculation means for calculating a predictive coefficient to be multiplied by each of elements of the tap using the parameter and a coefficient configuration value stored beforehand; and
allowing pixel value calculation means for calculating a value of the output pixel by performing a product-sum operation of the calculated predictive coefficient and each of the elements of the tap.

10. A program allowing a computer to function as an image processing apparatus comprising:
parameter input means for receiving a parameter including an output phase which corresponds to coordinates of an output pixel, a size of the output pixel, and a variable used for a condensing model;
tap extraction means for extracting a tap including a pixel value of a focus pixel which corresponds to the output phase of an input image and pixel values of neighboring pixels of the focus pixel;
predictive coefficient calculation means for calculating a predictive coefficient to be multiplied by each of elements of the tap using the parameter and a coefficient configuration value stored beforehand; and
pixel value calculation means for calculating a value of the output pixel by performing a product-sum operation of the calculated predictive coefficient and each of the elements of the tap.

11. An image processing apparatus comprising:
a parameter input unit that receives a parameter including an output phase which corresponds to coordinates of an output pixel, a size of the output pixel, and a variable used for a condensing model;
a tap extraction unit that extracts a tap including a pixel value of a focus pixel which corresponds to the output phase of an input image and pixel values of neighboring pixels of the focus pixel;
a predictive coefficient calculation unit that calculates a predictive coefficient to be multiplied by each of elements of the tap using the parameter and a coefficient configuration value stored beforehand; and
a pixel value operation unit that calculates a value of the output pixel by performing a product-sum operation of the calculated predictive coefficient and each of the elements of the tap.
